(19) United States
(12) Patent Application Publication
(10) Pub. No.: US 2004/0046658 A1
(43) Pub. Date: Mar. 11, 2004

(54) Dual watch sensors to monitor children

(76) Inventors: Jon Turner, San Antonio, TX (US); Shannon Turner, San Antonio, TX (US)

Correspondence Address: William B. Nash, JACKSON WALKER L.L.P., Suite 2100, 112 E. Pecan Street, San Antonio, TX, 78205, US

(21) Appl. No.: 10/627,221

(22) Filed: Jul. 25, 2003

Related U.S. Application Data
(60) Provisional application No. 60/401,779, filed on Aug. 8, 2002.

(51) Int. Cl. G08B 1/08

(52) U.S. Cl. 340/539.11; 340/539.32; 340/573.4

(57) ABSTRACT

A multi-unit, watch style electronic locator system. A transceiver is worn on the wrist of the caregiver, and transceiver units are worn on the wrists of the children. Each transceiver unit sends out a unique code on the same frequency. The transceiver then detects the separate codes transmitted, and determines when any one of the signal strengths are weak, indicating any one of the children's transceivers are out of range, and sounds an alarm. The transceiver watch has buttons to program range distance, and buttons for the number of children monitored. The transceiver can have visual indication showing which child is out of range, and uses the same buttons to set the detection delay for when any one child transceiver is out of range. Codes transmitted from the child watches are unique to the child watch and to the set of child watches monitored by the single caregiver watch.

This Application claims priority from Provisional Patent Application No. 60/344,700 filed Aug. 8, 2002.

### BACKGROUND OF THE INVENTION

1. Field of the Invention

The present invention relates to electronic child locators, allowing the parent or caregiver the ability to receive an audible or vibration alarm from a portable device when one or more children wearing a another portable device have wandered outside a predetermined, adjustable range from the parent or caregiver device.

2. Background Information

To reduce the number of child abductions due to preoccupied or distracted parent or caregivers, electronic locators commonly use a system having a device worn by a child that transmits a radio signal to a transceiver worn by the caregiver, which determines that the transceiver on the child is out of range by sensing the signal strength of the received signal. One of the problems frequently encountered is that the electronic locators need to be used in environments that vary in size, space or the amount of walls and corners. Consequently, a wearer of the locator does not know how such various environments will effect the detection range. The parent will find locating the child harder in a smaller, crowded, environment over a larger, less crowded, environment if the range of the locator is fixed. Another frequent problem is that the number children that need to be monitored by a single caregiver transceiver may vary or be more than one. A further frequent problem encountered is the larger number and variety of radio transmitters such as cell phones, pagers, etc.

There is a need for an electronic child locator system in which the caregiver unit allows the caregiver to program the number of child units that are simultaneously monitored using an unique address or code transmitted from the child unit which would avoid interference or jamming from other sets of children-parent units, to easily and quickly program the maximum allowable distance between the caregiver and child before the alarm is sounded, and to reliably indicate the direction of the child unit relative to the parent unit would be desirable.

A variety of electronic location devices have been proposed to solve some of the above problems. Many such devices include a transmitter that is worn on a child and receiver or direction finder that notify caregivers or security persons when the transmitter is outside of a fixed range. Exemplary electronic location devices of this type are shown in: U.S. Pat. No. 5,289,163 issued to Perex et al; U.S. Pat. No. 5,689,240 issued to Traxler; U.S. Pat. No. 5,923,255 issued to Vahdatshoar; and U.S. Pat. No. 6,078,260 issued to Desch. Other devices use long range transmitter and/or receiver combinations, such as cellular phones or GPS, to locate a missing person. Exemplary devices of this type are disclosed in: U.S. Pat. No. 5,021,794 to Lawrence; U.S. Pat. No. 5,742,233 issued to Hoffman et al.; U.S. Pat. No. 5,905,461 issued to Neher; and U.S. Pat. No. 5,936,530 issued to Meinhold.

In addition, U.S. Pat. No. 5,677,673 to Kipnis et al discloses a locator of a plurality of objects each having a receiver unit and having a transmitter unit.

It would be desirable to have an electronic location system which is adjustable in setting the distance at which an alarm on a caregiver's device sounds when the child's transmitter is outside of that adjustable distance and which provides an indication of the child's direction relative to the parent when the child's transmitter has exceeded that set distance.

In one example, U.S. Pat. No. 5,617,074 to White discloses a child finder worn on the child which sends a signal to a caretaker's unit. The caretakers receiver as disclosed in FIG. 7 shows a distance programmer.

In still another example, U.S. Pat. No. 5,119,072 to Hemingway describes a pair of transceiver units wherein a desired distance or range is preset and an alarm is sounded when the distance between the transceiver units is exceeded. The alarm circuit is operated by measuring the field strength of the carrier component of the signal generated by the child transceiver unit. When the strength of the carrier component falls below a threshold value, an alarm on the guardian transceiver unit is sounded.

In a further example, U.S. Pat. No. 4,899,135 to Ghahariiran discloses a device having two transceivers which will sound an alarm when a preset distance between them is exceeded.

In another example, the article entitled; “Next Up For Wireless Communication: The Computer Chip Itself”, 1995-2002, Science Daily Magazine; discloses that silicon chips or computer chips will be built using wireless communication with antennas installed onto chips.

In another example, U.S. Pat. No. 5,812,056 to Law discloses a child locator and caregiver monitor. A transmitter worn by the child transmits to a caregiver receiver. The caregiver receiver detects when the child transmitter is outside a preset range and is configurable to set a maximum allowable distance between the child and caregiver units before an alarm is sounded. The child and caregiver units are capable of remotely establishing an operating address and time marker. If the caregiver unit detects other similarly configured units operating in the vicinity of a child/caregiver pair or if the caregiver unit does not receive a communication from its corresponding child unit for a predetermined number of occurrences of its time marker, the caregiver unit is able to establish a new operating address and/or time marker with its corresponding child unit to avoid possible interference or jamming with other similar units operating in the vicinity.

It would be desirable to have a portable electronic location system in which the location of a child wearing a child unit relative to the parent unit can be reliably and inexpensively determined.

In one example, U.S. Pat. No. 6,441,778 to Durst discloses a pet locator wherein a locating device is attached to an animal. The locating device contains a GPS receiver which receives the current location of the animal. That location is transmitted via radio frequency to a fixed base station. Also to Durst, U.S. Pat. No. 6,518,919 discloses a mobile object locator wherein a locating device is attached to an object whose location is to be determined. The locating device contains a GPS receiver which receives the current location of the object and transmits that location to a fixed base station via radio frequency, two-way paging, or satellite communication.

A shortcoming in the above referenced inventions is that they either lack the ability to disclose to the monitoring or parent unit the location of the monitored or child unit, or provide a method of disclosing that location information that is prohibitively expensive.

None of the above inventions and patents, taken either singly or in combination, is seen to describe the instant invention as claimed.

### SUMMARY OF THE INVENTION

The present invention is an electronic child locator system which uses a portable parent unit having a transmitter and a receiver and a plurality portable child units each having a transceiver. Each child unit is preferably in the form of or contained in a watch encouraging each child to wear it at all times. The portable parent unit is also preferably in the form of or contained in a watch. The portable parent unit allows the parent to easily and quickly program the maximum allowable distance between the parent and child before the alarm is sounded or a vibrator is activated. The portable parent unit allows the parent to easily and quickly program the number of child units that are simultaneously monitored using an unique address or code transmitted from the child unit. Each system of portable parent unit and plural child units are distinguished from other similar systems by setting and programming address codes in both the child unit and the parent unit.

Accordingly, it is a principle object of the invention is to provide an electronic child locator system having plural child units and a single parent unit which avoids interference or jamming from other similar sets of plural children—single parent units, and any other similar single child single parent units, other transmitter or transceiver devices such as pagers, cell phones, GPS devices, etc., that maybe found in the same environment or range.

It is another object of the invention to provide electronic child locator used in multiple environments that vary in size, space or the amount of walls and corners by providing a parent unit that is easily and quickly programmed by extra switches on a watch that also contains the parent transceiver, detection and programming units.

It is a further object of the invention to provide an electronic child locator system where the number of children and child units to be monitored by a single parent unit transceiver is programmed easily and quickly by extra switches on a watch that also contains the parent transceiver, detection and programming units.

It is a further object of the invention to provide an electronic child locator system where the number children and child units to be monitored by a single parent unit transceiver is plural; the parent can use visual indicator on the parent watch unit to determine which particular one or more child is missing, when the particular one or more child units goes out of the programmable range sounding the single audio alarm or vibrator.

It is still a further object of the invention to provide an electronic child locator system where the general direction of the child transceiver units relative to the parent transceiver unit is automatically ascertainable.

It is a further object of the invention to provide an electronic child locator system where the parent unit and child units all contain a panic button which when activated will sound an audible alarm or vibration on the parent unit if depressed by one of the child units and on any one or all of the child units if depressed by the parent unit.

It is an object of the invention to provide a programmable detection delay in the parent watch unit for each of the child units to be monitored.

It is another object of the invention to provide an electronic child locator system having plural child units and a single parent unit which use computer chip communication.

It is another object of the invention to provide an electronic child locator system having plural child units and a single parent unit which have the dual function of telling time thereby encouraging children to wear the child unit.

It is another object of the invention to provide an electronic child locator system having a single parent unit which alerts the parent of the missing child via alarm sound or vibration.

It is an object of the invention to provide an electronic child locator system in which the child units and parent unit are constructed of waterproof material.

It is another object of the invention to provide an electronic child locator system in which the child units are constructed with a cut-proofband and coded lock so that the child unit will not be removable except by a parent or caregiver.

It is a further object of the invention to provide an electronic child locator system having child units which are tamper resistant and signal the parent unit if an attempt is made to modify the settings of any child unit.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1A is an environmental view of a child watch containing a transceiver to monitor children according to the present invention.

FIG. 1B is an environmental view of a parent watch containing a transceiver to monitor children according to the present invention.

FIG. 2 is an electronic block diagram of the parent transceiver unit.

FIG. 3 is an electronic block diagram of the child transceiver unit.

Similar reference characters denote corresponding features consistently throughout the attached drawings.

### DETAILED DESCRIPTION OF THE PREFERRED EMBODIMENTS

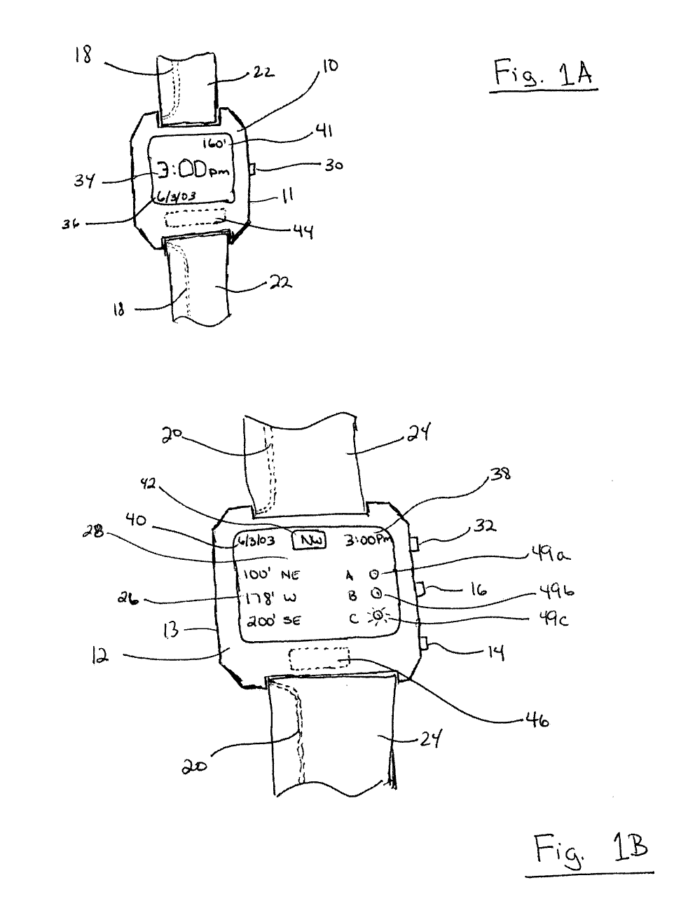

The present invention is an electronic child locator system shown in FIGS. 1A and 1B. In FIG. 1A, a set of child transceiver units (10) are radio linked to a single parent transceiver unit as shown in FIG. 1B. Alternatively, the units are linked by way of Bluetooth, WiFi, two-way directional radio, or signal interference/cutoff. In operation, if anyone of the child transceiver units, FIG. 1A, is detected to be outside a preprogrammed range, an alarm will sound or vibrate on the parent transceiver unit, FIG. 1B. The parent unit (12) has a switch (14) to program the range at which the alarm will sound or unit will vibrate, when any child unit (10) in FIG. 1A is beyond that range or distance. Additionally, the parent unit (12) in FIG. 1B, uses switch (16) to program the number of child units (10) in FIG. 1A, to be monitored in the programmed range.

The parent unit (12) and the child units (10) maybe tamper resistant watch cases (11 and 13) which include the time telling feature as shown in FIGS. 1A and 1B. The protective casing for the units are more durable than an average watch case.

Antennas, (18) in FIG. 1A and (20) in FIG. 1B, are mounted within the cut proof or tamper resistant watch bands (22) in FIG. 1A and (24) in FIG. 1B. The ends of the child bands (22) may be provided with a locking mechanism (not shown) to further ensure that the bands cannot be easily removed. Antennas, (18) in FIG. 1A and (24) in FIG. 1B could be embedded inside the watch enclosure or embedded on the computer or communication chips inside the watch enclosure. The visual indicators (26) in FIG. 1B on the watch face (28) of the parent watch (12) allow the parent to determine the distance and direction for each monitored child unit (10).

The parent unit (12) and the child units (10) each include panic buttons, (30) in FIG. 1A and (32) in FIG. 1B, which will trigger an alarm on each child unit (10) if the panic button of a parent unit (32) is on or will trigger the parent unit (12) if the panic button of a child unit (30) is pressed.

Each child unit (10) and the parent unit (12) will have the capability to show the current date and time, (34) and (36) in FIG. 1A and (38) and (40) in FIG. 1B. Each child unit will also display the distance from the child to the parent (41).

In addition to displaying the directions of each child unit (10), the parent unit (12) will also display the current direction (42) the parent unit (12) is facing.

Each child unit (10) and the parent unit (12) have a code setter chip (44) in FIG. 1A and (46) in FIG. 11B, which are used to relate the parent unit (12) and the child units (10) to each other.

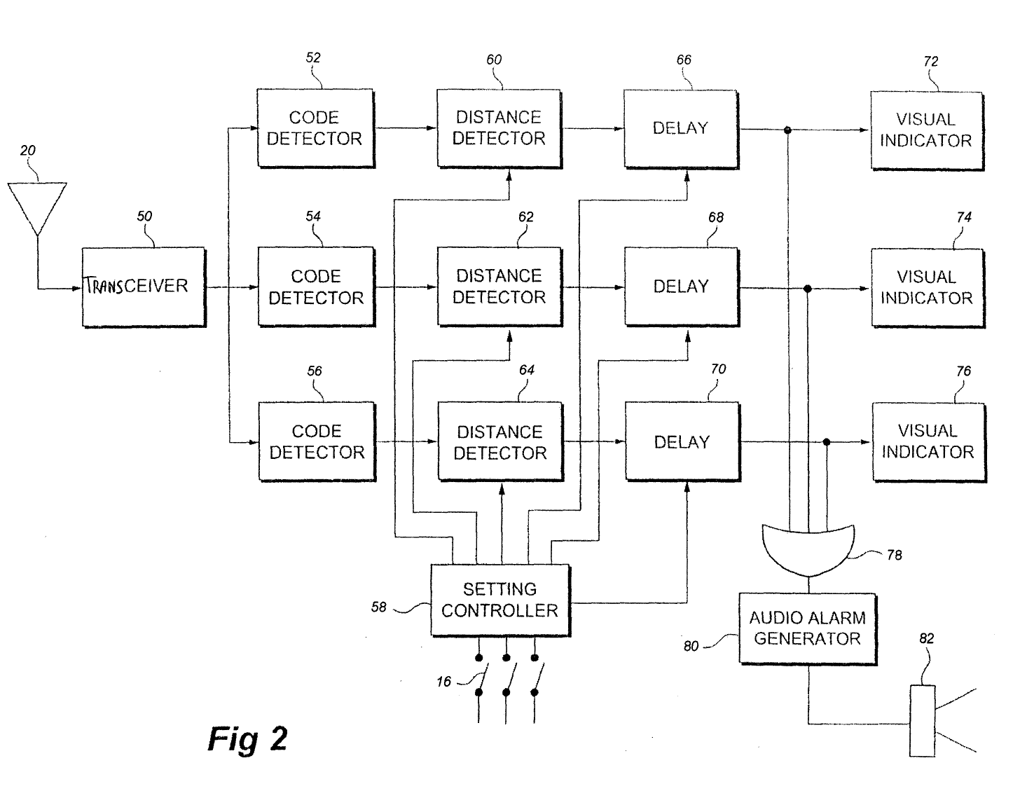

The electronic transceiver unit mounted inside the parent's watch (12) of FIG. 1B has circuitry as shown, in FIG. 2. In FIG. 2, the electronic transceiver is coupled to an antenna (20) which provides a received signal to a receiver (50) having a modulation type and frequency tuned to the same frequency and modulation type as the transceivers of the child units as is well known in the communication art. The transceiver (50) and antenna (20) are designed to have a reception range dictated by a maximum programmable detection range, modulation type and frequency and power output of the matching child transceiver units as is well known in the communication art. In the embodiment of the instant invention, the maximum programmable range could be 20, 50, 100, or a variable amount as dictated by a visual monitoring of children by parents within the environment. The direction of the signals transmitted by each child unit relative to the parent unit will be determined as is well known in the communication art.

The transceiver (50) then provides a demodulated signal to three code detectors (52), (54), and (56) which are connected in parallel to the transceiver (50). The number of code detectors depends on the designed maximum programmable number of children to be monitored or what is practical as to the number of children any one parent can monitor at the same time. Each of the code detectors (52), (54), and (56) correspond to a corresponding one of the programmable number of child watch units to be monitored. The codes to be detected can be any type electronic signal such as a pulse, audio tone, or digital logic signal etc, as is well known in the electronics art.

The first kind of code or address to be detected by all the code detectors (52), (54) and (56) are those indicating a single adult code designed or programmed to be the same type originally generated by each child transceiver in the same set transmitting to the single adult transceiver. The second kind of code or address to be detected individually by code detectors (52), (54), and (56) are those indicating which one of the corresponding child watch transceivers within the same set generated that particular code. Each code detector (52), (54), and (56) outputs a signal generated by a corresponding one of the child transceivers, if it detects both the first kind of code and the second kind of code. These codes may be programmably set by switches that are internal or hidden in the watch since they would be used rarely, (44) in FIG. 1A and (46) in FIG. 1B.

Each one of the distance and direction detectors (60), (62), (64) inputs the signal from the corresponding one of the code detectors (52), (54), and (56) and a corresponding signal from the setting controller (58). The corresponding signal from the setting controller (58) enables or disables a corresponding one of the distance and direction detectors (60), (62) and (64) based on the parent programming how many or which child unit to monitor through programming switch (16). The corresponding signal from the setting controller (58) also sets the signal strength to be detected for each one of the corresponding distance and direction detectors (60), (62) and (64) based on the parent programming the range at which to monitor the child through programming switch (14). Each one of the distance and direction detectors (60), (62) and (64) determine if the signal strength from the corresponding one of code detectors (52), (54), and (56) are within the particular range programmed for the corresponding child watch. The number of distance and direction detectors would depend on the designed maximum programmable number of children to be monitored or what is practical as to the number of children any one parent can monitor at the same time.

The programmed signal strength of the child watch signal determines the distance of the child watch from the parent watch. Each of the distance and direction detectors (60), (62), and (64) outputs a digital logic signal the active logic level of which indicates a corresponding child's watch is out of range.

Optionally, the digital logic signal output from each of the distance and direction detectors (60), (62), and (64) is input to a corresponding one of the delay circuits (66), (68), and (70) and a corresponding programming signal is input from setting controller (58). The corresponding signal from the setting controller (58) sets an amount of delay for a corresponding one of the delay circuits (66), (68) and (70) based on the parent programming the amount of delay through programming switch (14). Each of the delay circuits (66), (68) and (70) provides a programmed amount of delay to the corresponding digital logic signal.

The digital logic signal output from the each of the delay circuits (66), (68), and (70) are input to plural input of a logic OR gate (78) which will output a single active logic level if any one or any two or all three of the logic signals from the delay circuits are at an active logic level. Thus, if any one, any two or all three of the child watch units are out of range, the output of logic OR gate (78) will have an active logic signal output. All three logic signals from the delay circuits (66), (68), and (70) will be at an inactive logic level while all of the child units are within a corresponding programmed range.

The active logic signal output of the logic gate (78) is input to the audio alarm generator (60) which will cause the audio alarm generator (80) to produce an audio electronic signal for speaker (82) or vibrating motor. Thus, the alarm sound will be heard or a vibration felt by the parent wearing the parent unit when any one or two or all three of the child units is out of range. An inactive logic signal output of the logic gate (78) will not activate audio alarm generator (80) when none of the child units is out range.

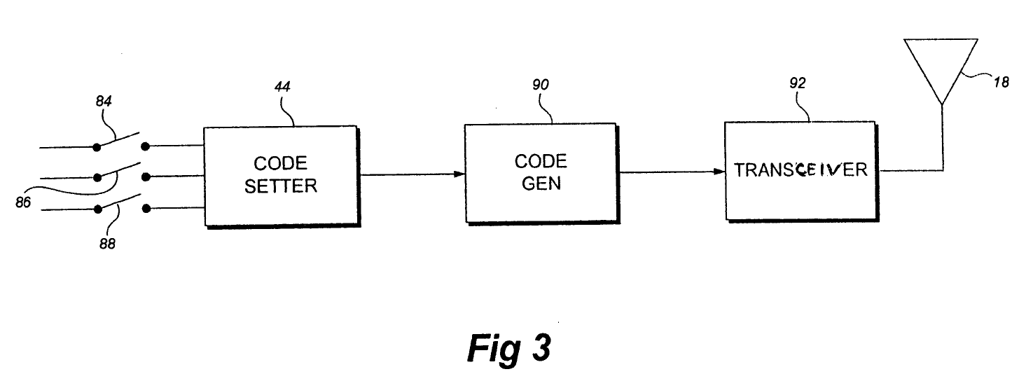

Each of the delay circuits (66), (68), and (70) outputs are connected to corresponding inputs of the visual indicators (72), (74), and (76). Individual indicators (72), (74), and (76) will light up or activate only when the logic level outputs from the delay circuits (66), (68) and (70) are at an active logic level when a corresponding child watch unit is out of range. Therefore, the visual indicators (49a), (49b), and (49c) in FIG. 1B [indicators (72), (74), and (76) of FIG. 3] on the watch face (28) of the parent watch (12) allow the parent to distinguish which child has gone out of range of the parent when the audio alarm has sounded. Visual indicator (49c) is shown in an activated state.

The parent transceiver unit circuitry of FIG. 2 and antenna (20) may be included in or made a part of a computer communication chip inside the parent watch unit, if the reception range is acceptable. The parent transceiver unit may include the time telling function in analog or digital format.

As seen in FIG. 1A, each of the child electronic transceiver units are mounted within a child watch (10). Each child watch transceiver contains switches (84), (86), and (88) as shown in FIG. 3, that are hidden or mounted away inside the watch transceiver unit (10) in FIG. 1A, since they are accessed less often and must be kept away from the children's ability to manipulate.

The switches (84), (86), and (88) in FIG. 3 program the codes or addresses that each of the child transceiver units of FIG. 3 will transmit. The switches (84), (86), and (88) are connected and input to the code setter (44). Code setter (44) allows two kinds of codes to be programmed by the switches and stored. One code setting provides a unique code of the particular child watch with respect to other child watches in the same set of child parent watch units. Another code setting provides a unique code that represents the particular set of child parent units. In other words, a code setting that will associate the child watch within a set with only one parent unit watch transceiver.

The code setter (44) in each of the child watch units constantly provides the kind codes to be generated to the code generator (90). Code generator (90) in each of the child watch units generates the unique code signals to be transmitted by the transceiver (92).

All the parts in each of the child watch transceiver units operate constantly as long as power to the unit is supplied or not turned off.

The transceiver (90) in each of the child watch units modulates and transmits the unique code signals to through the antenna (18) using a chosen frequency, modulation type, and output power as is well known in the communications art.

The child transceiver unit circuitry of FIG. 3 and antenna (18) may be included or made a part of a computer communication chip inside the child watch unit, if the transmission range is acceptable. The child transceiver unit may include the time telling function in analog or digital format. Thus, children will be encouraged to wear the child transceiver unit.

Communication between the child transceiver units (10) and the parent transceiver unit (12) may be either by two-way radio frequency or by an industry accepted communication protocol such as Bluetooth, WiFi, two-way directional radio, or signal interference/cutoff. An advantage of utilizing an industry standard communication such as Bluetooth is the cost and power savings associated with an efficient, low-cost radio system.

It is to be understood that the present invention is not limited to the embodiments described above, but encompasses any and all embodiments within the scope of the following claims.

What is claimed:

1. An electronic child location system, comprising:
a plurality of child unit watches having a code setter, a code generator, transceiver and an antenna;
a parent unit watch having an antenna, a transceiver, plural code detectors, plural distance and direction detectors, a setting controller, a logic circuit, an audio alarm generator, a visual indicator, and a speaker element;
each of said child unit watches code setters programming unique codes for each said child unit watch coupled to said code generator for generating said codes and further coupled to said child transceiver for generating a radio transmission signal and further coupled to said child antenna for transmitting said radio transmission signal;
said parent unit watch antenna receiving said radio transmission signal from each of said child unit watches and coupled to said parent transceiver for demodulating said child radio transmission signal, and further coupled to said plural code detectors for detecting said child codes and further coupled to said plural distance and direction detectors for detecting programmable signal strengths outside of a range of values based on inputs from said setting controller, each of said plural distance and direction detectors coupled to inputs of said logic circuit for detecting if any one or any two or all three of outputs of said plural distance and direction detectors indicates signal strength that is out of range, said logic circuit reporting the direction from which each said child radio transmission originated, and further coupled to said audio alarm or vibration generator for generating an audio alarm output to said speaker element.

2. The electronic child location system of claim 1 further comprising panic buttons on said parent unit and on each of said child units which will produce an alarm sound or vibration on said parent unit if any of said child unit panic buttons is pressed on a child unit and said panic button on said parent unit will produce an alarm on all child units if said parent panic button is pressed on said parent unit.

3. The electronic child location system of claim 1 wherein the cases of said child units are tamper resistant.

4. The electronic child location system of claim 1 wherein the band of said child units are cut-proof and contain a locking mechanism for lockably connecting the first end of said band to the second end of said band.
